(19) United States
(12) Patent Application Publication
(10) Pub. No.: US 2008/0080676 A1
(43) Pub. Date: Apr. 3, 2008

(54) Method and system for evaluating analog telephone lines

(75) Inventors: Cameron Milne, Gloucester (CA); Alex F. Milne, Gloucester (CA)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Nortel Networks Limited

(21) Appl. No.: 11/540,371

(22) Filed: Sep. 29, 2006

(51) Int. Cl. H04M 1/24

(52) U.S. Cl. 379/29.01

(57) ABSTRACT

A method and apparatus for determining a plurality of parameters indicative of performance of an analog telephone line is disclosed. The method includes sequentially performing a plurality of tests on the analog telephone line. The method further includes sequentially indicating results of the plurality of tests using a same set of visual indicators. In one embodiment, the performing the plurality of tests includes performing a second and a third sequential test upon detection of sequential activation of a test initiation input device. In another embodiment, the determining a plurality of parameters includes determining any one of loop current, ring voltage and ring trip energy of the analog telephone line.

### FIELD OF THE INVENTION

The present invention relates to telephonic communications, and in particular to a method and system for evaluating an analog telephone line in order to assess its adequacy for use.

### BACKGROUND OF THE INVENTION

As new infrastructure configurations, new products and new vendors enter the telephonic communications market, it can become difficult for telephonic equipment providers to evaluate new products and service offerings for proper operation with their equipment. Namely, loop current, battery voltage, ring voltage and ring trip energy are elements of a telephonic system that are crucial to the integrity and functionality of the system. Battery voltage is the voltage that exists on a working telephone line. The battery voltage is present at all times on a working telephone line. Loop current is applied to a telephone line when the handset is picked up. Loop current provides the energy required for the telephone handset to operate and provides supervision that informs the telephone central office that the handset is ready to make a call or is answering a call. Ring voltage is the voltage existing on the telephone line when a call is being made to the telephone handset, prompting the handset to ring. Ring trip energy is the energy that must be absorbed during the transition from a call being placed to a call being connected.

Battery voltage, loop current, ring voltage, and ring trip energy, however, cannot be measured directly with a conventional multimeter. Loop current and ring trip energy require a precision load to be placed across the telephone line while the measurement is being recorded. Ring voltage and ring trip energy require a device that can detect when ringing is occurring and take measurements at the proper time. In the case of ring voltage, the instrument must also take a series of measurements over time to determine the actual root mean square (RMS) value of the complex waveform. When measuring ring trip energy, an instrument must be able to measure the total dynamic power dissipated by the load in the transition from ringing to off hook, and the instrument must also be able to determine if the ring current exceeds the maximum allowable. These dynamic measurements can be captured by conventional test equipment, but the required equipment is bulky, expensive and requires a higher level of expertise to use.

While it is possible to obtain analog line installation measurements and network configuration information from the carrier before installing certain telephonic equipment, carriers are typically reluctant to share this information, if it is even available. Further, the information may not always be up to date. Alternatively, equipment may simply be installed without regard to testing, upon which corrective steps can be taken in the event of failure or inoperation. Unfortunately, this requires replacement of damaged equipment, resulting in loss of money for an equipment provider to replace the damaged equipment, loss of time and money for customers while defective equipment is replaced and loss of time and money for partners of an equipment provider who must perform the replacement.

In view of the above-described shortcomings, there is a need for a simplified and more efficient way to assess whether analog phone line operation parameters are within specification.

### SUMMARY OF THE INVENTION

The present invention advantageously provides a method and apparatus for determining a plurality of parameters indicative of performance of an analog telephone line. In one embodiment, the present invention provides a hand held device that uses an inexpensive microcontroller that is able to assess whether analog phone line parameters are within specification and convey such information through a simple display. In addition, an embodiment of the present invention provides a device that is portable, quick to setup and requires minimal training to use.

In accordance with one aspect, the present invention provides a method for determining a plurality of parameters indicative of performance of an analog telephone line. The method includes sequentially performing a plurality of tests on the analog telephone line. The method further includes the capability to sequentially indicate the stored results of the plurality of tests using the same set of visual indicators. In one embodiment, performing the plurality of tests includes performing a second and a third sequential test upon detection of sequential activation of a test initiation input device. In another embodiment, determining a plurality of parameters includes determining any one of loop current, ring voltage and ring trip energy of the analog telephone line.

In accordance with another aspect, the present invention provides an apparatus for determining a plurality of parameters indicative of performance of an analog telephone line. A probe is couplable to the analog telephone line. A set of indicators provides a visual indication of each value corresponding to the plurality of parameters. A processor such as a microcontroller is configured to sequentially perform a plurality of tests on the analog telephone line via the probe and uses the same set of indicators to provide a visual indication of results of each of the plurality of tests.

In accordance with still another aspect, the present invention provides an apparatus for determining a plurality of parameters indicative of performance of an analog telephone line. The apparatus includes a set of test result indicators and a probe couplable to the analog telephone line. The apparatus further includes a test activation input device, a load switch and a power supply. A microcontroller is configured to sequentially perform a plurality of tests on the analog telephone line via the probe and to cause the set of test result indicator lights to provide a visual indication of results of each of the plurality of tests.

### BRIEF DESCRIPTION OF THE DRAWINGS

A more complete understanding of the present invention, and the attendant advantages and features thereof, is more readily understood by reference to the following detailed description when considered in conjunction with the accompanying drawings wherein:

FIG. 1 is a top view of a device constructed in accordance with the principles of the present invention;

FIG. 2 is a block diagram showing an exemplary electrical circuit of the device of FIG. 1, in accordance with one embodiment of the present invention;

FIG. 3 is a schematic diagram showing an exemplary embodiment of the device of FIG. 2, constructed in accordance with the present invention; and

FIGS. 4 and 5 are a flow chart showing a measurement process in accordance with one embodiment of the present invention.

### DETAILED DESCRIPTION OF THE INVENTION

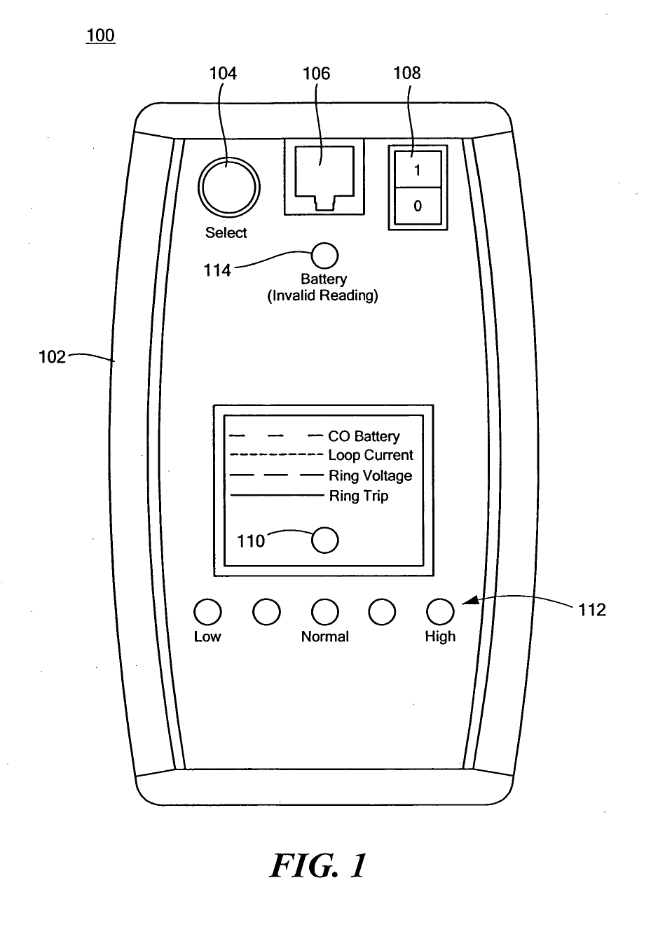

Referring now to the drawing figures in which like reference designators refer to like elements, there is shown in FIG. 1 a device 100 constructed in accordance with one embodiment of the present invention. Device 100 is a handheld device having a housing 102 constructed of a common semi-synthetic polymerization product such as plastic. The housing 102 includes a variety of text imprinted on it, so as to indicate the functions of the various features of the device 100. Device 100 includes a button 104 for activating various functions of the device 100, an analog telephone line jack 106 that serves as a probe into which the analog telephone line being analyzed is inserted, and an on/off switch 108 for turning the device 100 on or off. The button 104 protrudes through the housing 102. The analog telephone line jack 106 can accept RJ-45 and RJ-11 telephone line plugs but can be arranged with other jacks as may be needed to couple the probe to different physical phone line configurations. The device 100 also includes a status Light Emitting Diode (LED) 110 for indicating which performance parameter is being analyzed and a set of indicators 112, such as LEDs, for indicating the magnitude of each performance parameter. An LED 114 indicates the status of the battery of the device 100.

Using the device 100, a user can test various performance parameters of an analog telephone line inserted into the jack 106. The performance parameters include Central Office (CO) battery, or telephone line voltage, loop current, ring voltage, and ring trip energy. The device 100 uses the LED 114 to indicate whether the battery of the device 100 has sufficient charge to power the device 100. By pressing the button 104, the user indicates which performance parameter is being tested by the device 100. LED 110 indicates, by the form in which it is illuminated (i.e., pulsing, rate of pulse, continuous illumination), which performance parameter is being tested by the device 100. Further, the set of indicators 112 indicate the results of each performance parameter tested by the device 100.

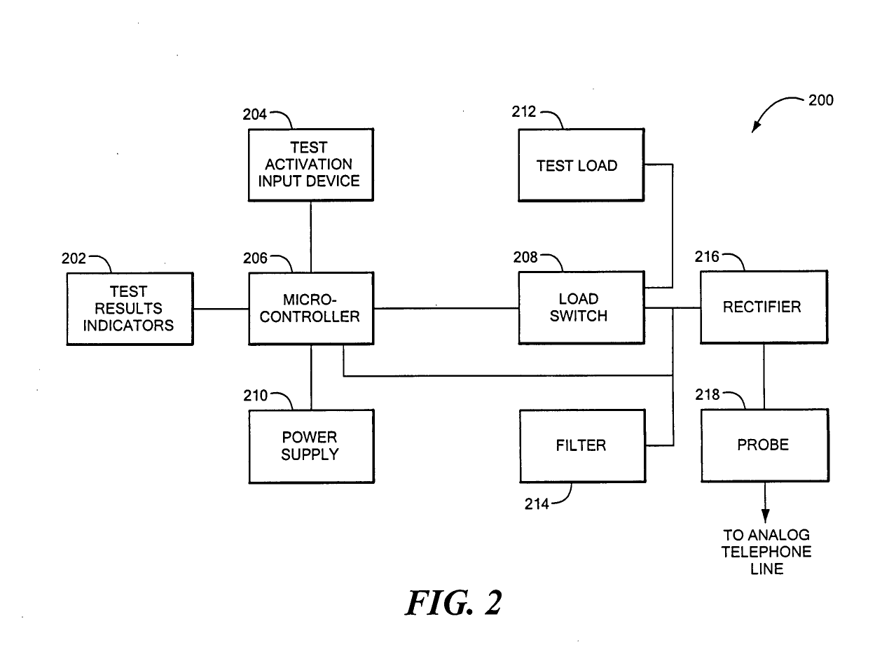

FIG. 2 is a block diagram 200 showing the main components of the device 100 in accordance with one embodiment of the present invention. FIG. 2 shows that the device 100 includes a test activation input device 204, shown as a button 104 in FIG. 1. Other embodiments of a test activation input device 204 include an electro-conductive sensor or a data input port. Device 100 also includes test results indicators 202, shown as LED indicators 112 in FIG. 1. Other embodiments of test results indicators 202 include a Liquid Crystal Display (LCD), an audio output device and a data output port. The device 100 also includes a power supply 210 that can be a nine volt battery or any other portable power supply module.

The device 100 includes a microcontroller 206 or any other suitable processing unit that can perform and/or control the functions described herein. The microcontroller 206 manages the components of the device 100 and performs the calculations necessary to evaluate the performance parameters of the analog telephone line being tested. The test results indicators 202, the test activation input device 204 and the power supply 210 are all electrically connected to the microcontroller 206.

Also connected to the microcontroller 206 is a load switch 208, that is used to place a load onto the analog telephone line being tested, as explained in greater detail below. The load switch 208 is connected to the test load 212 that includes a filter 214 for eliminating extraneous signal information when evaluating the performance parameters of the analog telephone line being tested. FIG. 2 also includes a rectifier 216 connected to the test load 212 and a probe 218. The probe 218, shown as jack 106 in FIG. 1, connects to the analog telephone line. The rectifier 216 rectifies the signal from the analog telephone line such that the probe 218 can be connected to the telephone line without regard to polarity. The microcontroller 206 contains an analogue to digital converter (ADC), used to measure the input from the rectifier 216 after the signal is scaled by a series of resistors.

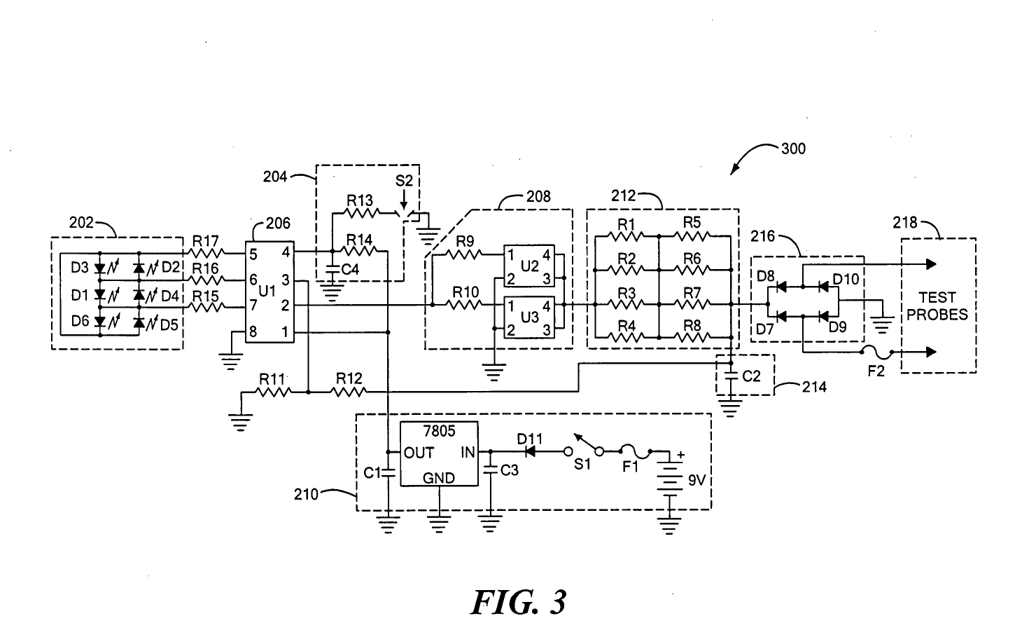

FIG. 3 is an exemplary schematic diagram for a circuit 300 for the device 100, constructed in accordance with one embodiment of the present invention. Reference is also made to Table 1. Table 1 provides an exemplary list of components suitable to implement the circuit 100.

TABLE 1

| Component | |
|---|---|
| Reference | Component Description |
| C1 | 0.1 μF 50 V |
| C2 | 680 pF 600 V |
| C3 | 0.33 μF 15 V |
| C4 | 0.01 μF 15 V |
| D1, D4 | GREEN LED |
| D2, D6 | RED LED |
| D3, D5 | YELLOW LED |
| D7–D10 | 1N4005 |
| D11 | 1N5818 |
| F1 | 0.125 Amp Picofuse |
| F2 | 1.0 Amp Picofuse |
| R1–R8 | 1 kΩ 1%, ½ Watt |
| R9, R10, R13 | 100 Ω 5%, ¼ Watt |
| R11 | 10.0 kΩ 1%, ¼ Watt |
| R12 | 1.00 mΩ 1%, ¼ Watt |
| R14 | 4.7 kΩ 5%, ¼ Watt |
| R15–R17 | 75 Ω 5%, ¼ Watt |
| U1 | PIC12F675 8-bit CMOS Microcontroller |
| U2–U3 | IRFN320 |
| U4 | 78L05 5-volt Voltage Regulator |

The schematic diagram of FIG. 3 corresponds to the block diagram of FIG. 2. LEDs D1, D2, D3, D4, D5 and D6 in combination with resistors R15, R16 and R17 correspond to test results indicators 202 of FIG. 2, that are used, among other things, to indicate the results of the performance parameters being tested. LEDs D1-D6 can be a combination of colored LEDs, such as red, green or yellow LEDs where green indicates passage, yellow indicates a slight out of tolerance condition and red indicates failure. Microcontroller U1 corresponds to microcontroller 206 that manages the components of the device 100 and performs the calculations necessary to evaluate the performance parameters of the analog telephone line being tested. Microcontroller U1 also performs analog to digital conversion of signals. The push button module consists of resistors R13 and R14, capacitor C4, and grounded push button S2 that corresponds to test activation input device 204.

Circuit 300 further includes a power supply module 210 having a voltage regulator U4, capacitors C1, C3, diode D11, on-off switch S1 (corresponding to on/off switch 108 of FIG. 1), fuse F1 (that can be a picofuse of 0.125) and a nine volt power supply. The power supply module corresponds to power supply 210 of FIG. 2. Circuit 300 includes a load switch module having integrated circuits U2, U3 (which can be transistors in 4-pin dip packages), that serve as switches, and damping resistors R9-R10 to prevent oscillation of the paralleled devices. The load switch module corresponds to load switch 208 of FIG. 2 that is used to switch a load onto the analog telephone line being tested. Test load 212 includes resistors R1-R8. The load 212 is used to load the analog telephone line being tested. Capacitor C2 corresponds to filter 214 of FIG. 2 that is used to filter out high frequency noise components from signals on the analog telephone line being tested. Resistors R11 and R12 can be used to scale down the input voltage provided to the microcontroller 206 from 500 to 5 volts.

A full wave rectifier bridge having diodes D7-D10 is connected to the test probes 218 via a fuse F2 (that can be a picofuse 1.0 Amps). The full wave rectifier bridge corresponds to rectifier 216 of FIG. 2 that rectifies the signal from the analog telephone line such that the probes (corresponding to probes 218 of FIG. 2) can be connected to the telephone line without regard to polarity.

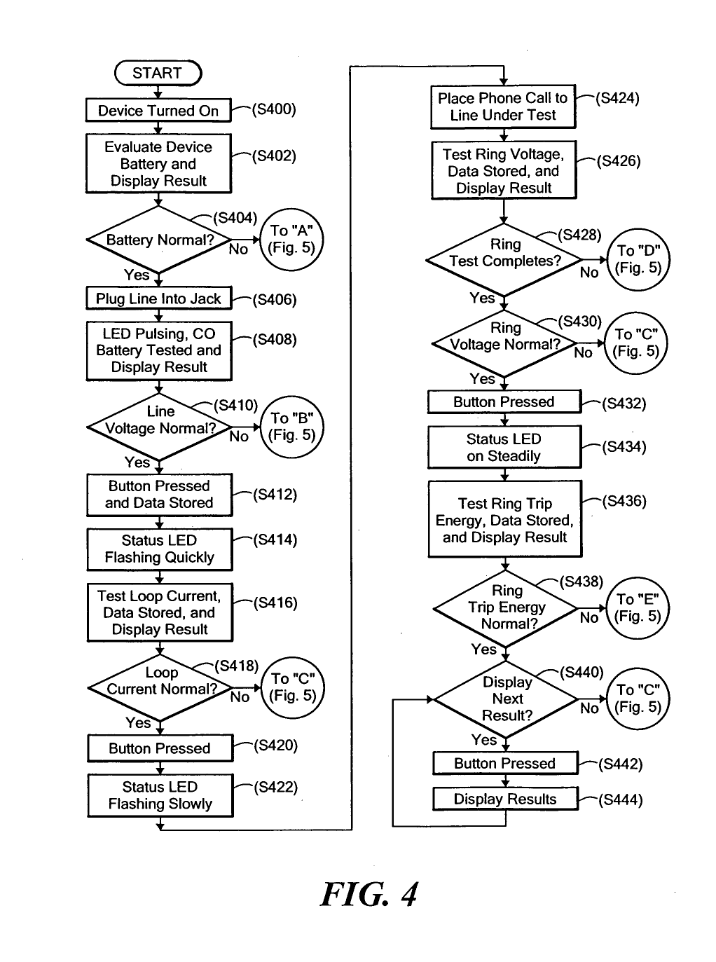

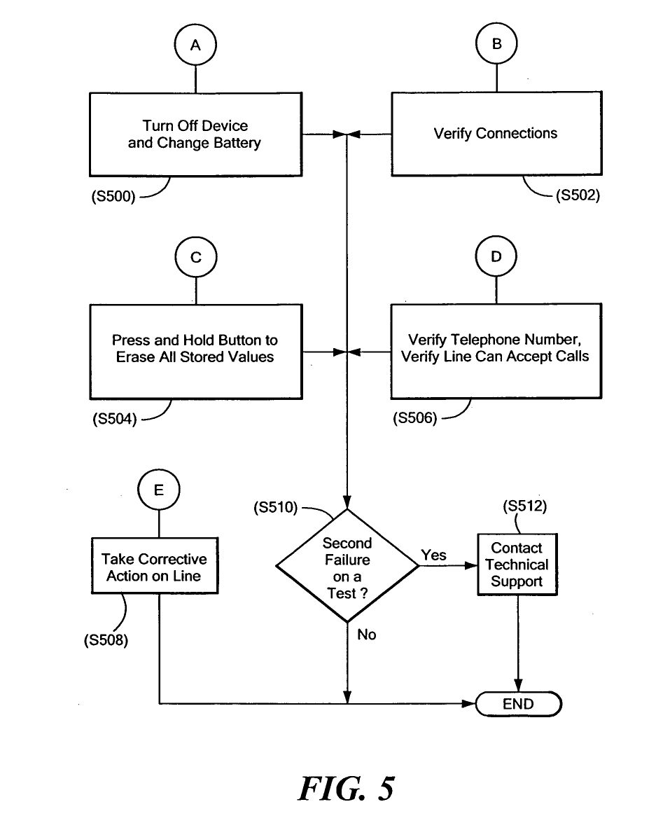

FIGS. 4 and 5 show a flow chart of the operational measurement process of the device of FIGS. 1-3. To operate the device 100, the user begins in step by turning on the device 100 using the on-off switch 108 (step S400). At step S402 the status of the battery of device 100 is evaluated by taking a voltage measurement (circuitry not shown in FIGS. 2-3). The result is displayed as follows (step S404). If the battery of the device 100 is sufficient to power the device 100, LED 110 pulses in a green color. LED 114 is red and only comes on if there is sufficient power in the battery to illuminate LED 114 and the device supply voltage is out of tolerance. Obviously, if the battery is dead, no LEDs light. If the battery is good and power supply output is within tolerance, LED 114 will not light. Accordingly, if the battery of the device 100 is not sufficient to power the device 100, the LED 114 either is not illuminated or illuminates in a red color and step S500 (FIG. 5) is performed, for example, by the user. Of note, the steps shown in FIG. 5 (steps S500-S512) are steps that can be performed by a user to aid his/her usage of the device and facilitate further testing and/or repair of the phone line under test.

In step S406, the user proceeds to plug the analog telephone line being analyzed into the analog telephone line jack 106. To indicate that the Central Office (CO) battery, or telephone line voltage, is being tested the LED 110 pulses in step S408 and the line voltage test is performed by the microcontroller 206 by measuring the voltage present across probe 218. The result is displayed using test results indicators 202 (see FIG. 2).

If the telephone line voltage operates within established parameters (step S4120, the middle green LED of LED indicators 112, in the range labeled “Normal” is illuminated if the measured voltage is near the middle of the acceptable range or one of the two yellow LEDs are illuminated if the voltage is still considered normal, but is not quite centered. For example, if the telephone line voltage measures between 42-52 volts, the line is deemed to be operating within the center of the established range and the green LED illuminated. If the line voltage is measured at 36-42 volts, or 52-56.5 volts, voltage is still considered normal, but one of the two yellow LEDs is illuminated (one for the low side of normal and the other for the high side of normal). If the telephone line voltage does not operate within established parameters, the first or last LED of LED indicators 112, labeled “Low” or “High,” is illuminated depending on whether the voltage was less than 36 volts or greater than 56.5 volts. Step S502 (FIG. 5) is performed, for example, by the user.

If the line voltage is normal, the user presses the button 104 to activate the next phase of testing by microcontroller 206 (step S412), namely loop current testing, and the line voltage test result data is stored in memory of the device 100. To indicate that loop current is being tested the LED 110 is flashed rapidly (step S414). In step S416, the device 100 subsequently tests and displays the loop current test result. The device 100 simulates a set going off-hook by placing a load across the analog telephone line, taking the analog telephone line off-hook for a predetermined period of time (250 ms, for example), switching the test load 212 onto the line and taking a current measurement from the analog telephone line. Also in step S416, the microcontroller 206 stores the information garnered from testing the loop current.

If the loop current operates within established parameters (step S418), the middle green LED of LED indicators 112, in the range labeled “Normal,” is illuminated, thereby indicating that the measured current is near the middle of the acceptable range. If one of the two yellow LEDs is illuminated, the current is still considered normal, but is not quite centered. For example, if the loop current measures between 25-35 milliamps, the line is deemed to be operating within the center of the established range and the green LED is illuminated. If the loop current is measured at 20-25 milliamps, or 35-60 milliamps, loop current is still considered normal, but one of the two yellow LEDs is illuminated (one for the low side of normal and the other for the high side of normal). If the loop current does not operate within established parameters, the first or last LED of LED indicators 112, labeled “Low” or “High,” is illuminated depending on whether the current was less than 20 milliamps or greater than 60 milliamps. In that case, step S504 (FIG. 5) is performed, for example, by the user.

If the loop current is normal, the user presses the button 104 to activate the next phase of testing by microcontroller 206 (step S420), namely ring voltage testing. To indicate that ring voltage is being tested the LED 110 is flashed slowly (step S422). Subsequently, in step S424, a telephone call is placed to the line being tested by either the user of device 100 or a third party. In step 426, the microcontroller 206 tests the ring voltage by detecting a ring voltage that is higher voltage than normal. Subsequently, a voltage reading is taken from the analog telephone line for a predetermined period of time (250 ms, for example) after detecting the ring voltage. In one embodiment, the microcontroller 206 determines whether the ring voltage is balanced or unbalanced on a first ring and measures the RMS value of the voltage on the second ring. Also in step S426, the microcontroller 206 stores the information garnered from testing the ring voltage and the result is displayed.

If the ring voltage is within established parameters, the middle green LED of LED indicators 112, in the range labeled “Normal” is illuminated, thereby indicating that the measured voltage is near the middle of the acceptable range. If one of the two yellow LEDs is illuminated, the voltage is still considered normal, but is not quite centered. For example, if the ring voltage measures between 75 and 95 volts, the line is deemed to be operating within the center of the established range and the green LED illuminated. If the ring voltage is measured at 65-75 volts, or 95 to 104 volts, ring voltage is still considered normal, but one of the two yellow LEDs is illuminated (one for the low side of normal and the other for the high side of normal). If the ring test did not complete (step S428), the process continues at step S506 (FIG. 5). If the ring test completes, but the ring voltage does test as operating within established parameters (step S430), the first or last LED of LED indicators 112, labeled “Low” or “High,” is illuminated depending on whether the ring voltage was less than 65 volts or greater than 104 volts and step S504 (FIG. 5) is performed, for example, by the user.

In step S432, the user presses the button 104 to activate the next phase of testing by microcontroller 206. To indicate that ring trip energy is being tested the LED 110 is illuminated continuously and is steadily on (step S434). In step S436, the ring trip energy test results are displayed. The ring trip energy is determined by taking the analog telephone line off-hook for a predetermined period of time (1 second, for example), measuring the ring trip energy and then placing the analog telephone line back on-hook. The microcontroller 206 takes the analog telephone line off-hook by switching the load 212 onto the line and places the analog telephone on-hook by removing the load 212. Note this step terminates the incoming test call. Also in step S436, the microcontroller 206 stores the information garnered from testing the ring trip energy

If the ring trip energy is within established parameters (step S438), the middle green LED of LED indicators 112, in the range labeled “Normal,” is illuminated, thereby indicating that the measured trip energy is near the middle of the acceptable range. If one of the two yellow LEDs is illuminated, the trip energy is still considered normal, but is not quite centered. For example, if the trip energy measures between 0.5-1.0 Joule, the line is deemed to be operating within the center of the established range and the green LED illuminated. If the trip energy is measured at 0.25-0.5 Joules, or 1.0-2.0 Joules, trip energy is still considered normal, but one of the two yellow LEDs is illuminated (one for the low side of normal and the other for the high side of normal). If the ring trip energy is measured at less than 0.25 Joules, this is not considered problematic. If the trip energy does not operate within established parameters, the last LED of LED indicators 112, labeled “High,” is illuminated, thereby indicating that the trip energy was greater than 2.0 Joules. In this aspect of testing, the test results for the power component of the trip energy are indicated by which color LED indicator is illuminated. The present invention also measures the current component of the ring trip energy. If, during testing the ring trip energy, the current component exceeds a predetermined value, the LED indicator used to indicate the overall ring trip energy power value is set to flash. The predetermined current value can be based on, for example, the Telcordia Technologies GR-1089 standard. In the event of failure, step S508 (FIG. 5) is performed, for example, by the user.

Once testing is complete, the user can review the testing results on test results indicators 204 (step S440). This is done by activating the test activation input device 204, e.g., pressing the button 104, for a predetermined period of time, such as less than one second. The first activation (step S442) causes the microcontroller 206 to present the results of the first test, e.g., the CO battery test (S444). The repeated activation of the button 104 causes microcontroller 206 to step through the stored test results. The test whose results is being displayed is indicated by the status LED 110, with the results of the test being shown on LED indicators 112. The user can repeatedly step through the tests and results by pressing the button 104 for less than the reset time. As is described below, holding the button 104 for more than the reset time, e.g., 1 second, erases all stored values and returns the device to the ready to test state, e.g., step S406.

FIG. 5 is a flow chart continuing the flow chart of FIG. 4, in accordance with one embodiment of the present invention. Step S500 flows from a failed battery test result (step S404 in FIG. 4). In step S500, the user turns off the device 100 and checks and/or changes the device battery. Step S502 flows from a failed line voltage test (step S410 in FIG. 4.) In step S502, the user verifies all connections to jack 106. Step S504 flows from a failed loop current test (step S418 in FIG. 4), a failed ring voltage test (step S430 in FIG. 4) or where the user wishes to reset the device 100 (step S440 in FIG. 4). In step S504, the user presses and holds the button 104 to erase all values stored by the device 100 for the predetermined time period, e.g., greater than 1 second.

Step S506 flows when the ring test does not complete (step S428 in FIG. 4). In this case, the user verifies the telephone number corresponding to the jack the device 100 is plugged into and verifies that the line is configured to accept calls.

Step S508 flows from a failed ring trip energy test (step S438 in FIG. 4). In step S508, corrective action must be taken on the line under test.

In the case of steps S500-506, if the failure of the corresponding test is the first failure, then, in step S508, the user retests. If the test fails again (step S510) technical support is contacted (step S512).

In one embodiment of the present invention, the device 100 includes a sleep function wherein if the device is not in use for a predetermined period of time (such as 4.5 minutes), the microcontroller 206 turns off the LEDs of circuit 300 so as to conserve battery power. The sleep function can be initiated in the middle of a testing scenario. If the user decides to continue the testing scenario after the sleep function has initiated, the user can press button 104 to wake up the device 100 and continue the testing scenario from where he left off. After being woken up, the device 100 continues to possess in memory any information stored during the testing of performance parameters of the analog telephone line.

Of note, although the tests are presented in a specific sequence in FIGS. 4 and 5, the present invention is not limited to such. The tests can be programmed to be performed in any order. Further, although the flow shown in FIGS. 4 and 5 shows that the results of failed tests are not stored, the present invention is not limited to such. The results of failed tests can be stored for subsequent presentation/display to the user in accordance with steps S440-S448.

When and if telephone standards change over time, it should be noted that the computer program can be modified to incorporate new values of the thresholds that determine when the LEDs D1-D6 of FIG. 3 are illuminated.

Advantageously, the present invention provides a device that sequentially performs a group of tests on an analog telephone line and presents the results using the same set of visual indicators. In other words, a simple set of visual indicators, such as a group of LEDs, is used to display the results of each of the sequentially performed tests.

The present invention can be realized in hardware, software, or a combination of hardware and software. An implementation of the method and apparatus of the present invention can be realized in a centralized fashion in one apparatus, or in a distributed fashion where different elements are spread across several interconnected apparatuses. Any kind of apparatus adapted for carrying out the methods described herein is suited to perform the functions described herein.

A typical combination of hardware and software could be an apparatus having one or more processing elements and a computer program stored on a storage medium that, when loaded and executed, controls the components within the apparatus such that it carries out the methods described herein. The present invention can also be embedded in a computer program product, that comprises all the features enabling the implementation of the methods described herein, and when loaded in a device is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A method for determining a plurality of parameters indicative of performance of an analog telephone line, the method comprising:
sequentially performing a plurality of tests on the analog telephone line; and
sequentially indicating results of the plurality of tests using a same set of visual indicators.

2. The method of claim 1, wherein performing the plurality of tests includes:
performing a second and a third sequential test upon detection of sequential activation of a test initiation input device.

3. The method of claim 2, wherein performing a second and a third sequential test includes:
performing the second and a third sequential tests upon detection of sequential activation of a button.

4. The method of claim 2, wherein determining a plurality of parameters includes:
determining any one of line voltage, loop current, ring voltage and ring trip energy of the analog telephone line.

5. The method of claim 1, wherein performing the plurality of tests includes:
placing a load on the analog telephone line for a predefined period of time; and
measuring loop current of the analog telephone line while the load is placed on the analog telephone line.

6. The method of claim 5, wherein performing the plurality of tests further includes:
detecting a ring voltage on the analog telephone line; and
measuring the ring voltage for a predefined period of time after the ring voltage is detected.

7. The method of claim 6, wherein performing the plurality of tests further includes:
placing the load on the analog telephone line for a predefined period of time after the ring voltage is detected; and
measuring ring trip energy over a predefined period of time.

8. The method of claim 1, wherein indicating results of the plurality of tests includes:
sequentially indicating results of the plurality of tests using a set of LEDs.

9. An apparatus for determining a plurality of parameters indicative of performance of an analog telephone line, the apparatus comprising:
a probe couplable to the analog telephone line;
a set of indicators, the set of indicators providing a visual indication of each value corresponding to the plurality of parameters; and
a processor configured for:
sequentially performing a plurality of tests on the analog telephone line via the probe; and
causing the same set of indicators to provide a visual indication of results of each of the plurality of tests.

10. The apparatus of claim 9, wherein the plurality of parameters comprises loop current, ring voltage and ring trip energy of the analog telephone line.

11. The apparatus of claim 10, wherein the indicia for reporting each of the plurality of parameters comprises writing on the housing.

12. The apparatus of claim 11, wherein the set of indicators comprises a set of LEDs.

13. The apparatus of claim 12, wherein the set of indicators further provide a visual indication of a magnitude of each of the plurality of parameters.

14. The apparatus of claim 9, further comprising a button disposed on the housing.

15. The apparatus of claim 14, wherein the processor is configured for:
performing a second and a third sequential test upon detection of sequential activation of the button.

16. The apparatus of claim 9, wherein at least one of the plurality of tests includes:
placing a first load on the analog telephone line for a predefined period of time; and
measuring loop current of the analog telephone line while the first load is placed on the analog telephone line.

17. The apparatus of claim 9, further comprising a housing mateable with the probe, the housing including an indicia for reporting each of the plurality of parameters, wherein the set of indicators is aligned with the indicia.

18. An apparatus for determining a plurality of parameters indicative of performance of an analog telephone line, the apparatus comprising:
a set of test result indicators;
a probe couplable to the analog telephone line;
a test activation input device;
a load switch;
a power supply; and
a microcontroller, the microcontroller:
sequentially performing a plurality of tests on the analog telephone line via the probe; and
causing the set of test result indicator lights to provide a visual indication of results of each of the plurality of tests.

19. The apparatus of claim 18, wherein the microcontroller is configured for:
sequentially performing the plurality of tests on the analog telephone line in response to activation of the test activation input device.

20. The apparatus of claim 18, wherein at least one of the plurality of tests includes placing a load on the analog telephone line using the load switch.

21. The apparatus of claim 20, wherein the set of test result indicators comprises a set of LEDs.

22. The apparatus of claim 18, wherein at least one of the plurality of tests is a ring trip energy test, the ring trip energy test including determining whether the ring trip current exceeds a predetermined value.
